(19) United States
(12) Patent Application Publication
(10) Pub. No.: US 2020/0385494 A1
(43) Pub. Date: Dec. 10, 2020

(54) METHOD FOR PRODUCING RESISTANT PEA DEXTRIN

(71) Applicant: ROQUETTE FRERES, Lestrem (FR)

(72) Inventor: Gérald WESOLEK, DROUVIN-LE-MARAIS (FR)

(21) Appl. No.: 16/971,643

(22) PCT Filed: Feb. 21, 2019
(86) PCT No.: PCT/FR2019/050398

§ 371 Date: Aug. 20, 2020

(30) Foreign Application Priority Data
Feb. 22, 2018 (FR) 18 51528

(51) Int. Cl. C08B 30/18; A23L 29/30

(52) U.S. Cl. CPC C08B 30/18; A23L 29/35

(57) ABSTRACT

The invention concerns a method for producing a resistant dextrin comprising: a) a step of dehydration and acidification of a pea starch in order to provide a dehydrated and acidified pea starch composition; b) a step of heat treatment of the starch composition provided in step a) in order to form a dextrinised starch; c) one or more steps of treating this dextrinised starch in order to form the resistant dextrin; d) a step of recovering this resistant dextrin. The invention also concerns a resistant pea dextrin having a fibre content according to standard AOAC 2001.03 of more than 60%, that can be obtained, in particular, according to the method of the invention, and the use of same in a food or pharmaceutical composition.

### FIELD OF THE INVENTION

The subject of the invention is a process for manufacturing resistant dextrins, a new resistant dextrin and also the use of this new resistant dextrin for pharmaceutical and food applications.

### TECHNICAL PROBLEM

Keen to find solutions that are beneficial to their health and well-being, the modern consumer is looking for foods and dietary supplements to fulfill these objectives.

Among the ingredients that make it possible to provide this type of food, those comprising fiber are of particular interest. In the recent change in dietary patterns, consumption of foods comprising this fiber, including soluble dietary fiber, has tended to decrease. This is notably linked to the fact that the agri-food industry has grown a lot in recent decades due to consumer demand for prepared products and that few fiber-based products easily usable by this industry have been proposed during this period.

Resistant dextrins are carbohydrate compositions comprising soluble dietary fiber. They have many advantages such as the nutritional advantages below. In addition to the fact that resistant dextrins are low in calories, they provide general well-being and in particular a beneficial effect on gut health. Furthermore, this soluble dietary fiber may make it possible to reduce the glycemia developed during the ingestion of sugary foods; this may be particularly advantageous especially for diabetic consumers. Resistant dextrins also have other functional advantages: their texturing function makes it possible to provide foods with a texture equivalent to sugary and/or fatty foods, while having reduced amounts of fat and/or sugar. Furthermore, resistant dextrins which are generally in the form of liquid aqueous solutions or in the form of powders present, for the agri-food industry, ease of use in food manufacturing processes.

In the present Application, a process for manufacturing a resistant dextrin is a process comprising a step of heat treatment, referred to as “dextrinization”, of a starch composition to form a dextrin, the dextrin thus obtained then undergoing various subsequent treatment steps. These possible subsequent treatment steps include chemical and/or enzymatic treatments, separation and purification.

A step of dextrinization of a starch composition may be carried out with high dry matter and under acidic conditions In the particular case of resistant dextrins, this dextrinization step is generally carried out by a heat treatment under specific conditions allowing the formation, and this being in significant amounts, of “atypical” bonds thus forming at this stage a starch referred to as “dextrinized starch”. These atypical bonds are bonds other than the alpha 1-4 and alpha 1-6 bonds which are naturally and mainly present in starch.

It has been observed by the Applicant that once this dextrinized starch has been formed, the abovementioned subsequent treatment steps could be problematic, in particular on an industrial scale, these problems leading to production shutdowns creating productivity losses and therefore economic losses. In particular, the process for manufacturing resistant dextrins generally comprises a step of filtration of the dextrinized starch; however, during this filtration step, the passage of this dextrinized starch can cause clogging of the filters after a certain time. This clogging may give rise to a loss of the filtration flow rate and, thus, a loss of productivity. Furthermore, it is also necessary, when this flow rate becomes too low, to clean the filter or even to replace it, this leading to a shutdown of the production of the resistant dextrin, which is particularly troublesome in the context of a continuous process for manufacturing this resistant dextrin. A similar problem also arises when the subsequent treatment step consists of a step of passing dextrifnized starch over resins, this step possibly being, for example, a demineralization step or a fractionation step. In addition to the fact that the clogging of these resins reduces the flow rate, it is also necessary to clean, or even change, these resins so as to regain the initial efficiency of the process.

Commercial resistant dextrins are generally based on corn (as such mention may be made of the Nutriose® FM product sold by Roquette® or Fibersol® product sold by Matsutani®) or based on wheat (the Nutriose FB® product).

Processes for manufacturing these resistant dextrins have been described in documents EP 0538146, EP 0530111, EP 0988323, EP 1006128 and EP 2820050. None of these documents describes the abovementioned problems, and no teaching appears therein to solve them. There is therefore no incentive to modify this teaching, in particular to resolve the problems which arose during the abovementioned subsequent treatment steps.

Document DE 10102160 A1 describes a process for manufacturing high molecular weight resistant starch from legume starch. This process includes enzymatic treatment using a pullulanase in aqueous solution with low dry matter (aqueous solution with 20% dry matter). This resistant starch is not a resistant dextrin which includes large amounts of fiber and large amounts of bonds other than alpha 1-4 bonds. Nor does the process include a step of dehydration of the starch and heat treatment of this dehydrated starch.

Document FR 2 955 861 A1 describes branched soluble glucose polymers having alpha 1-4 and alpha 1-6 bonds, with an alpha 1-6 bond content between 7 and 10%, a reducing sugar content between 25 and 35%, and also a molar mass Mw of between 50 000 and 150 000 daltons. This glucose polymer is not a resistant dextrin which includes large amounts of fiber and large amounts of bonds other than alpha 1-4 bonds.

Document FR 2 764 294 describes the manufacture of non-cariogenic polysaccharides comprising a step of extrusion at a temperature between 140 and 230° C. of a dehydrated and acidified starch.

It would therefore be advantageous to find new resistant dextrins but also manufacturing methods in which the manufacturing process is facilitated.

By carrying out numerous studies with a view to solving the abovementioned problems, the Applicant has succeeded in providing new resistant dextrins obtained from pea starch. Advantageously, the process for manufacturing these resistant dextrins is easy to implement. In particular, fewer problems are observed during the treatment steps subsequent to the dextrinization step compared to the prior art processes.

### SUMMARY OF THE INVENTION

Thus, one subject of the invention is a process for manufacturing a resistant dextrin, comprising:
a) a step of dehydrating and acidifying a pea starch to provide a dehydrated and acidified pea starch composition;
b) a step of heat treatment of the starch composition provided in step a) to form a dextrinized starch;
c) one or more steps of treating this dextrinized starch to form the resistant dextrin;
d) a step of recovering this resistant dextrin.

The process for manufacturing non-cariogenic polysaccharides of document FR 2 764 294 described above does not use pea starch as a raw material but a wheat, corn or potato starch. The examples in this document describe the manufacture of non-cariogenic polysaccharides using a wheat starch. This document does not attach any importance to the botanical origin of the starch since this origin is presented therein as irrelevant. Thus, this document does not state that the origin of the starch can have an effect on the properties of the non-cariogenic polysaccharides obtained or on their manufacturing process. Contrary to what was expected on reading this document, the Applicant has succeeded in obtaining new resistant pea dextrins, while improving the abovementioned treatment steps c).

In the process of the invention, the water content in the starch composition during at least one part of step b) may be less than or equal to 10%, generally less than or equal to 6%, for example less than or equal to 4%, by mass relative to the total mass of the composition.

The pea starch used in step a) may comprise a total lipid content of less than 0.10%, generally ranging from 0.01 to 0.08%, for example from 0.02 to 0.05%, in particular from 0.02 to 0.04% by dry mass relative to the dry mass of the starch.

The process further has the advantage of taking place more easily than using other types of starch, in particular when at least one treatment step c) comprises a filtration and/or demineralization and/or fractionation step subsequent to step b).

It is specified that in the present application, when ranges are indicated, each of the lower limits can be combined with each of the upper limits.

The pea starch used in step a) advantageously has an amylose/amylopectin mass ratio ranging from 25:75 to 50:50, preferably from 32:68 to 45:55.

The ash content of the pea starch used in step a) is advantageously less than 1%, for example less than 0.2%.

The pea starch used in step a) is preferentially a smooth pea starch of yellow pea type.

The pea starch used in step a) is advantageously a native starch.

The heat treatment step b) is generally carried out at least in part at a temperature ranging from 80 to 250° C., for example at a temperature ranging from 120 at 220° C., preferably at a temperature ranging from 160 to 210° C.

The heat treatment step b) is advantageously carried out in a reactor chosen from an extruder, a thin-film reactor or a thermostatic chamber, preferentially an extruder or a thin-film reactor, very preferentially a thin-film reactor.

The acidification of the starch during step a) can be carried out with an acid chosen from hydrochloric acid, sulfuric acid, nitric acid, phosphoric acid, citric acid or a mixture thereof, preferentially hydrochloric acid.

Moreover, at least one of the treatment steps c) of the process of the invention advantageously comprises a step of enzymatic hydrolysis of the dextrinized starch. Indeed, the advantages relating to the filtration and demineralization steps are particularly significant according to this variant.

Moreover, at least one of the treatment steps c) advantageously comprises a fractionation step. This step notably makes it possible to reduce the sugar content of the dextrinized starch.

The resistant dextrin recovered at the end of the process advantageously has from 15 to 45%, preferably from 20 to 42%, for example from 28 to 40%, of 1→6 glycosidic bonds relative to the total number of 1→2, 1→3, 1→4 and 1→6 glycosidic bonds.

The resistant dextrin recovered at the end of the process advantageously has a reducing sugar content of less than 30%, for example ranging from 3 to 25%, in particular ranging from 4 to 19%, more particularly from 4 to 12%, as glucose equivalent, by mass relative to the dry mass of the resistant dextrin.

Preferably, the resistant dextrin has:
a polydispersity index of less than 5, generally ranging from 1.5 to 4, and
a number-average molecular mass Mn of less than 4500 g/mol, generally ranging from 500 to 3500 g/mol, for example ranging from 800 to 3000 g/mol, in particular from 900 to 1500 g/mol.

The amount of fiber in this resistant dextrin according to standard AOAC 2001.03 is generally greater than 60%, preferentially ranging from 65 to 99%, generally from 70 to 95%.

Another subject of the invention also relates to a resistant pea dextrin having an amount of fiber according to the AOAC 2001.03 standard of greater than 60%. This pea dextrin can in particular be obtained by the process of the invention. The resistant pea dextrin according to the invention may have properties similar to those described for the resistant pea dextrins recovered at the end of the process according to the invention, in particular as regards the % of 1→6 glycosidic bonds relative to the total number of 1→2, 1→3, 1→4 and 1→6 glycosidic bonds, the content of reducing sugars, the polydispersity index and the number-average molecular mass Mn.

Yet another subject of the present invention is the use of the resistant pea dextrin of the invention in a food or pharmaceutical composition.

The invention will now be described in detail below.

### DETAILED DESCRIPTION OF THE INVENTION

The method according to the invention comprises a step a) of dehydrating and acidifying a pea starch to provide a dehydrated and acidified pea starch composition. The pea starch generally has a high starch content, often greater than 90% by dry mass relative to the dry mass of the pea starch. Preferentially, the starch content is greater than 95%, more preferably greater than 98%, or even greater than 99% or else greater than 99.5%, by dry mass relative to the dry mass of the pea starch.

The pea starch may have a low N 6.25 protein content, for example less than 2%, often less than 1%, preferably less than 0.5%, more preferentially between 0.1 and 0.35% by dry mass relative to the dry mass of the pea starch. This content can be determined by the Dumas method.

The pea starch advantageously has a total lipid content of less than 0.10%, generally ranging from 0.01 to 0.08%, for example from 0.02 to 0.05%, or even from 0.02 to 0.04% by dry mass relative to the dry mass of the pea starch. The Soxhlet method can be used to determine the total lipid content.

The pea starch has an amylose/amylopectin mass ratio advantageously ranging from 25:75 to 50:50, preferably from 32:68 to 45:55. This ratio is that generally observed in smooth pea starch of yellow pea type, which starch gives excellent results for providing the resistant dextrin of the invention. The amylose and amylopectin contents are themselves evaluated by the iodine complexation method.

Amylopectin comprises alpha 1-6 bonds, at specific locations in the structure of the starch, and this being in significant amounts unlike amylose. Thus, according to the variants, the pea starch has a particular alpha 1-6 bond content. Thus, with an identical manufacturing process, without being tied to any one theory, the resistant dextrin obtained from pea starch may have a structure that is slightly different from that of the resistant dextrins obtained with other starches. Furthermore, the initial structure of the pea starch may make it possible to explain the results obtained in the Examples section. Specifically, it appears that the resistant pea dextrins have, with an identical manufacturing process, a greater amount of fiber, in comparison with the resistant dextrins obtained from other starches such as for example corn or wheat, and this without the need for an additional fractionation step.

More precisely still, the pea starch advantageously has, by dry mass relative to the dry mass of the pea starch:
a starch content of greater than 90%, preferably greater than 95%, more preferably greater than 98%, or even greater than 99% or else greater than 99.5%,
a protein content of less than 2%, advantageously less than 1%, preferably less than 0.5%, more preferably between 0.1 and 0.35%,
a total lipid content of less than 0.10%, generally ranging from 0.01 to 0.08%, for example from 0.02 to 0.05%, or even from 0.02 to 0.04%.

One advantage of this pea starch useful in step a) is that it may have, owing to its intrinsic botanical nature, exceptional properties allowing it to be used in the process of the invention with the abovementioned advantages. Another advantage is that it can be obtained using an extraction process using almost exclusively or exclusively water as solvent, without using complex preparation steps. Advantageously, the pea starch extraction process useful in the invention does not use organic solvent. The pea starch can be extracted from peas using known processes such as the one described in document EP1400537.

Such starches are sold by the Applicant.

To provide the dehydrated and acidified composition of step a), an acidification stage and also a dehydration stage of the pea starch must be carried out. Preferably, the dehydration stage is carried out after the acidification stage. The water content in the starch composition can be measured by Karl-Fisher titration.

During the acidification stage, the amount of acid used in the process according to the invention is generally between 2 and 100 meq H+/dry kg of pea starch, advantageously between 5 and 50 meq H+/dry kg, and preferably between 10 and 30 meq H+/dry kg. It is preferable that the distribution of the acid in the starch is as homogeneous as possible. Various techniques can be used for the acidification of the starch, such as acidification, in the dry or liquid phase. Generally, this acidification is carried out by introducing an aqueous solution of acid into the pea starch.

This acidification stage can be carried out in batch mode or continuously. However, since the acidified starch may be intended to be used in a continuous modification process, it is preferred in the present invention to use a continuous acidification means to carry out a process as continuous as possible, and thus limit the non-productive operations (loading, unloading, emptying).

During the dehydration stage, which preferably takes place after the acidification stage, the starch is dehydrated in order to promote, during the following step b), the formation of atypical bonds. In fact, at equilibrium and under normal conditions, pea starch generally has a moisture content of around 12%, it being possible for this moisture content to be higher if an aqueous solution is added during the abovementioned acidification stage.

During the dehydration stage, it is preferable to take care not to promote the hydrolysis reactions because the various parameters favorable to this hydrolysis (high moisture content, temperature, acidity) are combined. The Applicant has been able to demonstrate that it would be better to favor, during this stage, continuous drying techniques that make it possible to reach the desired moisture content in a residence time of the order of a minute, or even a few seconds and thus minimize the starch hydrolysis reactions.

This drying stage can be carried out in any suitable type of drier and in particular in a fluidized bed dryer, an air flow dryer or a drum dryer.

It is also possible to carry out various drying stages during step a), for example firstly carrying out a first stage of drying the pea starch, followed by a starch acidification stage followed by a second stage of drying the acidified pea starch to complete step a).

Preferentially, at the end of step a), the water content in the starch composition is less than or equal to 10%, generally less than or equal to 6%, for example less than or equal to 4%.

The process according to the invention comprises a step b) of heat treatment of the composition provided in step a) to form a dextrinized starch. This step b) can be carried out so as to allow the formation, in significant amounts, of indigestible bonds, referred to as “atypical bonds”, other than the alpha 1-4 bonds mainly present in native starch. The treatment may include heating, generally at least in part at a temperature ranging from 80 to 250° C., for example at a temperature ranging from 120 to 220° C., preferably at a temperature ranging from 160 to 210° C. Advantageously, at least 50% of the time of the heat treatment step, preferentially at least 80%, very preferentially the whole of this step, is carried out at these temperatures.

During this step, it is also possible to concomitantly carry out continuous drying; thus in this case, the dehydration stage of step a) and the heat treatment of step b) can be carried out simultaneously. Depending on the configuration of the chosen reactor, any drying concomitant with heating can be carried out by passing an air flow or by a vacuum pump in order to extract the moisture.

At least during part of step b), the water content in the starch composition may be in the water content ranges for at least 50% of the time of the heat treatment step, preferentially at least 80%, preferentially for the whole of this step.

The heat treatment step may be carried out in a reactor chosen from an extruder, a thin-film reactor or a thermostatic chamber, preferentially an extruder or a thin-film reactor, very preferentially a thin-film reactor.

The use of an extruder to form a dextrinized starch, able to then be transformed into a resistant dextrin, has already been described in documents EP0538146, EP0530111 and EP0988323.

An extruder makes it possible to carry out heat treatments under pressure. It may be a single-screw extruder or a co-rotating or counter-rotating twin-screw extruder. Particularly advantageously, the extruder is a twin-screw extruder, in particular a co-rotating twin-screw extruder.

The extrusion step may further comprise a concomitant drying step of the dehydrated and acidified pea starch. This drying is preferably carried out by placing under vacuum, for example using a vacuum pump.

The screw(s) of the extruder may have a length/diameter ratio ranging from 5:1 to 50:1. The screw length may range from 0.5 m to 5 m. The screw speed of the extruder is adapted to the selected screw and the pea starch introduced; it may range from 100 to 500 revolutions per minute. The residence time is adapted by the various parameters in order to obtain a dextrinized starch at the end of this step.

As regards the thin-film reactor, a process for manufacturing resistant dextrin using this type of reactor was the subject of application EP 1006128. A thin-film reactor is understood to mean any type of reactor which makes it possible to apply a high temperature to the product for a short time, in order to obtain a significant transformation of the structure of the product, mainly at the glycosidic bonds, by simultaneously generating the least amount of degradation products possible. An example of a thin-film reactor that can be used is a turbodryer (for example of the VOMM® brand) or a continuous type mixer, especially a continuous type screw mixer. By way of example of a continuous type screw mixer, mention may be made of a BUSS type mixer sold by the company BUSS AG. With regard to the continuous type screw mixer, the mixer screw may have a length/diameter ratio ranging from 5:1 to 50:1. The screw length may range from 0.5 m to 5 m. The screw speed of the mixer is adapted to the selected screw and the pea starch introduced. The temperature is preferentially that mentioned above and the residence time is adapted by the various parameters in order to obtain a dextrinized starch at the end of this step. It may be particularly short, for example ranging from 3 to 15 seconds. The mixing step in the continuous type screw mixer may further comprise a concomitant drying step of the dehydrated and acidified pea starch. This drying is preferably carried out by placing under vacuum, for example using a vacuum pump.

As regards the thermostatic chamber, it may be any type of oven.

At the end of step b), the dextrinized starch is recovered.

The dextrinized starch obtained at the end of step b) may have a number-average molecular mass Mn at most equal to 4500 g/mol, generally ranging from 500 to 3500 g/mol, for example ranging from 800 to 3000 g/mol, in particular from 900 to 1500 g/mol.

The dextrinized starch obtained at the end of step b) may comprise an amount of sugars (that is to say an amount of saccharides with a degree of polymerization equal to 1 or 2) of generally less than 15%, for example less than 10%, in particular less than 5%, expressed by dry mass relative to the dry mass of dextrinized starch. Sugars are generally mainly made up of glucose, maltose and isomaltose.

The process according to the invention comprises one or more treatment steps c) of the dextrinized starch in order to form the resistant dextrin. These steps have different functions which will be disclosed below.

All of these treatment steps can be successively combined with one another. Therefore, and for reasons of simplicity in the understanding the description of the treatment steps c) which follows, it is specified that the terms “dextrinized starch” will be used, even if this dextrinized starch has previously undergone another treatment step. By way of example, in the following section, the terms “dextrinized starch” include a dextrinized starch as recovered in step b) having then undergone a first step of enzymatic hydrolysis.

These treatment steps c) are generally carried out on the dextrinized starch which is in the form of an aqueous solution. For each of these treatment steps, the concentration and the pH of the dextrinized starch solution can be adjusted beforehand so as to allow each of these steps to take place under good conditions.

One of the treatment steps c) advantageously comprises a step of reducing the molecular mass of the dextrinized starch. This step may be a step of enzymatic hydrolysis or a step of chemical hydrolysis of the dextrinized starch. Preferentially, this molecular mass reduction step is an enzymatic hydrolysis step.

In order to carry out this enzymatic hydrolysis step, the dextrinized starch is preferentially placed in a medium having a mass concentration of dextrinized starch, a pH and a temperature that are close to the optimal operating conditions of the selected enzyme. The amounts of enzymes are adapted by a person skilled in the art to allow the hydrolysis reaction under the selected conditions. The medium is advantageously held in a known reactor under these optimal operating conditions for the time to enable the reaction to take place. The enzymatic hydrolysis step can be carried out with one enzyme or a mixture of enzymes. The enzyme may be an amylase, in particular an amylase chosen from alpha-amylases, beta-amylases, pullulanases and gluco-amylases or amyloglucosidases, advantageously an alpha-amylase. By way of example, use may be made of a medium in which the dextrinized starch has a temperature ranging from 50 to 100° C. The pH may range from 3 to 5. The dry mass of the medium may range from 25 to 45%. This step may last from 30 minutes to 5 hours.

The molecular mass reduction step may also be carried out by acid hydrolysis using the same acids as those used during step b) and by adapting the conditions for hydrolysing the dextrinized starch, using a lower dry matter.

Since the molecular mass reduction step and in particular the enzymatic hydrolysis step may generate sugars, the dextrinized starch obtained at the end of the enzymatic hydrolysis step may comprise an amount of sugars (i.e. an amount of saccharides with a degree of polymerization equal to 1 or 2) greater than that of the dextrinized starch before this step, this amount generally being less than 20% of sugars, in particular less than 15%, for example less than 10%, by dry mass relative to the dry mass of the dextrified starch obtained at the end of this treatment.

One of the treatment steps c) may also include an enzymatic branching step using a branching enzyme such as a transglucosidase.

The process may also include a treatment step c) of treating the dextrinized starch using lipases such as lysophospholipase and/or phospholipase. The process may also include a treatment step c) of the dextrinized starch using hemicellulases.

These steps of enzymatic treatment of dextrinized starch (enzymatic hydrolysis, enzymatic branching, treatment using lipases and/or treatment using hemicellulases) are well known. They can be carried out separately or even concomitantly. Such steps are in particular described in documents U.S. Pat. No. 5,620,873 and US 2011020496.

At least one of the treatment steps c) is advantageously a filtration step. This filtration step, which is known per se, may in particular be carried out using known techniques of filter press, passing through diatomaceous earth or filtration by passing through a rotary vacuum filter (RVF).

At least one of the treatment steps c) may also consist of a demineralization step. This demineralization step can be carried out in a known manner by passing through anionic and/or cationic resin.

At least one of the treatment steps c) may comprise one or more bleaching steps. A bleaching means can for example be carried out by adsorption by bringing the dextrinized starch into contact with pulverulent or granular activated carbon. In the case of a bleaching step using pulverulent activated carbon, the Applicant has determined that high percentages of bleaching can be obtained by using large pore volumes of mesopores (pore radii between 1.5 and 25 nm and in particular between 4 and 20 nm). Successive bleaching operations can be carried out to optimize the bleaching. However, to avoid the loss of activated carbon, it is preferred in the context of the invention to use recyclable supports such as columns of granular blacks. The same process advantage is observed as for the filtration and demineralization step: the dextrinized starch useful for the invention causes less fouling of the granular black columns.

One of the treatment steps c) may also comprise at least one fractionation step. This fractionation step may in particular make it possible to reduce the sugar content of the dextrinized starch. In the context of the present invention, the fractionation step is intended to eliminate the smallest molecules of the dextrinized starch, and in particular to reduce the sugar content. This fractionation step makes it possible to collect a fraction of polysaccharides having characteristics of higher molecular masses and lower polydispersity index. This fractionation step may consist, for example, of a chromatographic separation step or of a membrane separation step.

This fractionation step may be carried out continuously or in batch mode.

Generally, the fractionation is carried out on dextrinized starch, optionally after having undergone a pretreatment step which may in particular be a molecular mass reduction step. The dextrinized starch may also have been subjected to a molecular mass reduction step, such as an enzymatic hydrolysis step.

The dextrinized starch subjected to the fractionation step is generally in the form of an aqueous solution.

For example, in the case of the chromatographic separation step, the solution may have a dry matter of between 20 and 60%, preferably between 25 and 55%. In the case of the membrane separation step, the solution may generally have a lower dry matter. The solution may have for example ranging from 2 to 50%, or even from 5 to 30%.

The step of fractionation by chromatographic separation is carried out in a manner known per se, in batch mode or continuously (simulated moving bed), over strong cationic resins of macroporous type, preferably loaded with alkali metal or alkaline-earth metal ions such as calcium and magnesium but more preferentially with sodium or potassium ions. Examples of such fractionations are described in particular in patents U.S. Pat. No. 3,044,904, U.S. Pat. No. 3,416,961, U.S. Pat. No. 3,692,582, FR 2 391 754, FR 2 099 336, U.S. Pat. No. 2,985,589, U.S. Pat. No. 4,024,331, U.S. Pat. No. 4,226,977, U.S. Pat. No. 4,293,346, U.S. Pat. No. 4,157,267, U.S. Pat. No. 4,182,623, U.S. Pat. No. 4,332,623, U.S. Pat. No. 4,405,455, U.S. 4,412,866, U.S. Pat. No. 4,422,881 and WO 92/12179. Preferably, with regard to the adsorbent, use is made of a strong cationic resin employed in sodium or potassium form, of macroporous type. The resins are advantageously of homogeneous particle size between 100 and 800 micrometers. It may be of polystyrenic type, comprising divinylbenzene (DVB). The macroporous strong cationic resin in potassium form can be chosen from the group consisting of Purolite® C141 with 5% DVB, Purolite® C145 with 8% DVB or Purolite® C150 with 12% DVB. The same process advantage is observed as for the demineralization resins: the dextrinized starch useful for the invention does not cause fouling of the adsorbent resin.

With regard to the step of fractionation by membrane separation, it may be carried out by nanofiltration, optionally with diafiltration. This separation step may be carried out using nanofiltration cartridges, for example of Desal® DK or DL type. The temperature conditions of the nanofiltered stream and the pressure applied to the membrane are adapted by a person skilled in the art. Membrane filtration produces a permeate which mainly comprises species of low molecular mass while the retentate mainly comprises polysaccharides of higher molecular mass. The conditions of the membrane filtration and in particular the choice of the membrane make it possible to modify the cut-off threshold and thus to eliminate, relatively substantially the glucose, maltose, etc. in the permeate. For example, a Desa®I DL type membrane makes it possible to reduce the amount of maltose in polysaccharides of higher molecular weight (retentate) more substantially than a Desal® DK type membrane. The same process advantage is observed as for the abovementioned filtration tools: the dextrinized starch useful for the invention causes less fouling of the membranes.

At the end of the fractionation step, the dextrin generally comprises less than 10% of sugars, for example less than 5%, in particular less than 1%, by dry mass relative to the dry mass of the composition. By carrying out this step concomitantly with the reduction in sugars in the resistant dextrin, its content of reducing sugars obtained after fractionation decreases.

In a nonlimiting manner, various preferred variants of the process of the invention are described below, which include various sequences of treatment steps c), which can themselves be combined in their preferred variants presented above.

According to a first preferred variant of the process of the invention, the treatment steps c) comprise:
C1) a molecular mass reduction step;
C2) a filtration step and/or a demineralization step.

According to a second preferred variant of the process of the invention, the treatment steps c) comprise:
C1) a filtration step and/or a demineralization step;
C2) a fractionation step.

According to a third preferred variant of the process of the invention, the treatment steps c) comprise:
C1) a molecular mass reduction step;
C2) a filtration step and/or a demineralization step;
C3) a fractionation step.

The process according to the invention also comprises a step d) of recovering the resistant pea dextrin obtained at the end of step(s) c). Without being bound by any one theory, the resistant pea dextrin has properties which are specific thereto, in particular owing to the structure of the starch particular to the starting starch used in the process of the invention but also all of the characteristics of the composition of the pea starch (impurities, etc.).

The resistant dextrin obtained may have from 15 to 45% of 1→6 glycosidic bonds, preferably from 20 to 42%, for example from 28 to 40% relative to the total number of 1→2, 1→3, 1→4 and 1→6 glycosidic bonds. The amounts of 1→2, 1→3, 1→4 and 1→6 glycosidic bonds can be determined by the conventional method known as the “Hakomori method”, this technique being described in the publication HAKOMORI, S., 1964, J. Biochem, 55, 205.

The resistant dextrin obtained may also have a reducing sugar content of less than 30%, for example ranging from 3 to 25%, in particular ranging from 4 to 19%. The content of reducing sugars is expressed as glucose equivalent, by dry mass relative to the dry mass of product analyzed, and it is measured by the BERTRAND method.

The resistant dextrin obtained may also have a polydispersity index of less than 5, generally ranging from 1.5 to 4. The resistant dextrin obtained may for example have a number-average molecular mass Mn at most equal to 4500 g/mol, generally ranging from 500 to 3500 g/mol, for example ranging from 800 to 3000 g/mol, in particular from 900 to 1500 g/mol.

This resistant dextrin obtained may have an amount of fiber according to the AOAC 2001.03 standard of greater than 60%, preferentially ranging from 65 to 99%, generally from 70 to 95%. This method makes it possible to completely determine the quantity of fiber of the resistant dextrins of the invention. The amount of this total fiber may in particular be adjusted by a person skilled in the art by modifying the heat treatment, enzymatic hydrolysis, branching and/or fractionation steps.

The abovementioned treatment steps, well known to those skilled in the art, are described in reference works in their field, such as, for example, Separation and Purification Techniques in Biotechnology, Dechow (Noyes publication, 1st Edition, 1989), Filtration Technologie [Filtration Technology], Meriguet G. (Techniques de I'ingénieur, Sep. 10 1997, Ref: J3510 v1) and Filtration membranaire (OI, NF, UF)—Applications diverses [Membrane Filtration (OI, NF, UF)—Various applications], Bourdon et al. (Techniques de I'ingénieur, Sep. 10 2006, Ref: J2796 v1).

The process according to the invention may also comprise a step of chemical modification of the resistant dextrin, for example by a step of hydrogenation or ozonolysis of resistant dextrin, these steps being already known furthermore.

The process according to the invention may also include an additional step of shaping this resistant dextrin. The resistant dextrin of the invention may be in the form of a concentrated aqueous solution, referred to as “syrup”, or in solid form.

The resistant dextrin, generally still in liquid form after the abovementioned treatment steps c), or even optional chemical modification steps, can be made into the form of a syrup using a concentration step, known per se, that makes it possible to adjust the dry matter content of the resistant dextrin syrup to the desired mass concentration. This concentration step can be carried out using any device allowing evaporation. This syrup may have a dry matter ranging from 60 to 90%, for example from 65 to 85%.

The resistant dextrin of the invention may also be made into solid form. Advantageously, the composition is in the form of a powder which is preferably a spray-dried powder. The process may thus comprise a step of concentration followed by a step of drying. The concentration step may be carried out using any type of evaporator and the drying step may especially be a step of spray drying or a step of granulation. These methods are well known to those skilled in the art.

The resistant dextrin of the invention can in particular be used in all of the already known applications of resistant dextrins. They may be used as an ingredient in human or animal pharmaceutical and food compositions.

Thus, one subject of the present invention is the use of the resistant dextrin obtained by the process according to the invention in a food or pharmaceutical composition.

Indeed, due to its high fiber content and low calorific value, such a resistant dextrin is of definite interest in many industrial applications, in particular in the agri-food or pharmaceutical industry, and in animal nutrition.

Food composition is understood to mean a composition intended for the feeding of human beings or animals. The term “food composition” encompasses foodstuffs and food supplements. Pharmaceutical composition is understood to mean a composition intended for a therapeutic use.

Examples of food compositions comprising said resistant dextrin are dairy products, yogurts, milk-based specialities, ice creams, milkshakes, smoothies, pastries, pies, puddings, biscuits, cookies, donuts, brownies, confectionery, chocolates, spreads, chewing pastes, chewing gum, candies, hard candies, alcoholic or non-alcoholic, carbonated or non-carbonated drinks, fruit juices, concentrated mixtures of fruit juices, flavored waters, powdered drinks, for example powdered chocolate drinks, soups, sauces, special nutrition compositions, in particular compositions for maternal and infant nutrition, for weight management, for sports nutrition, for the elderly and for clinical nutrition, fruit preparations, jams, cookies, cakes, snacks, pastries, coated or uncoated cereal bars and clusters, breads and brioches.

Examples of pharmaceutical compositions include medicines such as elixirs, cough syrups, lozenges or tablets, pastilles, veterinary products, diet products or hygiene products such as, for example, oral hygiene solutions, toothpastes and tooth gels.

Examples of such compositions using similar products, referred to as branched maltodextrins, are already described in documents EP1201133, EP1245578, EP1245582, EP1245580, EP1245581, EP1245579, EP1245161, EP1388294, FR2846518, EP1713340, EP1871394, EP2306846, EP2515910, EP2632428 and EP2919592. The resistant dextrins of the invention can be used as a replacement for these branched maltodextrins, according to the teaching of these documents which are incorporated by reference.

The invention will now be exemplified below in the following specific nonlimiting embodiments.

### EXAMPLES

### Example 1

### Preparation of a Resistant Dextrin With the Process According to the Invention

Pea starch: ROQUETTE® native pea starch. Native yellow smooth pea starch comprising, by dry mass relative to the dry mass of the pea starch, a protein content (N6.25) of 0.20%, a total lipid content of 0.03%, an ash content of 0.09% and a starch content of around 99.7%. The amylose:amylopectin ratio is 38:62. The equilibrium moisture content of the pea starch is 12%.

The composition is acidified with hydrochloric acid in a proportion of 17.6 meq H+/dry kg, then dried to a residual moisture content of 1.5% by introducing it into a fluidized air dryer.

This raw material is then introduced into a BÜSS® PR46 mixer maintained at a temperature of 200° C. and at a flow rate of 20 kg/h. The residence time is approximately 5 seconds.

The dextrinized starch is recovered at the outlet and has the molecular mass Mn presented in table 1.

This dextrinized starch then undergoes an enzymatic hydrolysis step, then being put into solution with 35% dry matter, this solution being adjusted to a pH of 4. An alpha-amylase is introduced into the medium (Termamyl® 120L, Novozymes®) and the medium is heated at 75° C. for two hours.

At the end of this enzymatic hydrolysis step, the dextrinized starch is passed through a rotary vacuum filter (RVF). This dextrinized starch is then brought into contact with granular charcoal and then filtered again. The dextrinized starch is then passed over ionic resins to demineralize it. Table 1 shows the level of ease of performing these steps (flow rate losses, need to clean the filters or resins, etc.).

The dextrinized starch is then recovered in the form of a liquid solution.

A portion of the dextrinized starch in the form of a liquid solution is brought to a dry matter of around 40% then the product is subjected to a fractionation step consisting of an SMB (simulated moving bed) chromatography step. After fractionation, the resistant dextrin recovered in the form of a solution having 20% dry matter comprises, by dry mass, a DP1-2 equal to 4.3% relative to the dry mass of the resistant dextrin. The properties of the resistant dextrin are listed in table 2.

The resistant dextrin is also evaporated to 70% dry matter and then is put into solid form by atomization.

### Example 2

### Preparation of a Resistant Dextrin With the Process According to the Invention

Example 2 differs from example 1 in that the fractionation step is carried out by adjusting the chromatography so as to reduce more significantly the amount of sugars, so that, by dry mass, the % DP1-2 is equal to 0.5% relative to the dry mass of the resistant dextrin. The properties of the resistant dextrin are listed in table 2.

### Counter-Example 1

### Preparation of a Resistant Dextrin With a Process Which is Not According to the Invention

This example is identical to example 2 and differs only in that corn starch (ROQUETTE®) is used instead of pea starch.

The same observations as for Example 1 are presented in Table 1.

### Counter-Example 2

### Preparation of a Resistant Dextrin With a Process Which is Not According to the Invention

This example is identical to example 2 and differs only in that wheat starch (ROQUETTE®) is used instead of pea starch.

The same observations as for example 1 are presented in table 1. Furthermore, the properties of the resistant wheat dextrin obtained before and after chromatography are also reported in table 2.

TABLE 1
properties observed for the various dextrinized starches

| | Dextrinized pea | Dextrinized | Dextrinized |
|---|---|---|---|
| | starch (Examples 1 | corn | wheat |
| | & 2) | starch (C Ex 1) | starch (C Ex 2) |
| Mn (g/mol) | 1250 | 1280 | 1280 |
| Filtration step | +++ | + | 0 |
| Demineralization step | +++ | + | + |

+++: no reduction in flow rate observed
++: slight reduction in flow rate
+: significant reduction in flow rate
0: reduction in flow rate requiring the cleaning of the filter or resin

The Applicant has been able to note that the filtration step on the rotary vacuum filter took place much more easily than when a corn starch or a wheat starch was used instead of the pea starch useful for the invention. The filtration flow rate is improved compared to the other dextrinized starches and no clogging of the filter was observed during the test.

As regards the demineralization step, it also takes place more easily, without clogging the demineralization resins.

This is all the more surprising since the molecular mass of the dextrinized starch is similar, regardless of the base used.

Table 2 demonstrates that the resistant pea dextrin of the invention has very advantageous properties, making it entirely suitable for use in food and pharmaceutical products.

TABLE 2
Properties of the resistant dextrins

| | | | C Ex 2 | |
|---|---|---|---|---|
| | | | before | |
| | Example 1 | Example 2 | chromato. | C Ex 2 |
| Mn (g/mol) | 1440 | 2090 | 1110 | 2420 |
| Mw (g/mol) | 3425 | 3980 | 3460 | 4475 |
| % fiber | 81% | 86% | 72% | 85% |
| Reducing | 8% | 5% | 11% | 5% |
| sugar content | | | | |
| (%) | | | | |
| 1 → 6 bonds | 30% | 30% | 29% | 35% |
| % DP1-2 | 4.3% | 0.5% | 12% | 0.5% |

It is interesting to note that the amount of fiber in the C Ex. 2 dextrin before chromatography has a lower fiber content than that of example 1. Thus, it appears that the particular structure of pea starch makes it possible to obtain, with an equivalent process, a higher fiber content and also a lower sugar content. Without being bound by any one theory, an explanation for this phenomenon could be that the structure of the resistant pea dextrin of the invention, although it cannot be distinguished from the resistant wheat dextrin by the methods used, has a different structure in its bonds.

The resistant dextrins of the invention can thus be used in the recipes described below.

### Example 3

### Yogurt

A yogurt can be made with the resistant dextrin of example 2 as an ingredient.

Ferments:

The ferments are supplied by the company CHR HANSEN® in lyophilized form.
a “traditional” ferment, a balanced mixture of the customary yogurt strains (Streptococcus thermophilus, Lactobacillus delbruekii sp. bulgaricus), reference YC-380.
a “modern” ferment made up of the same strains after adaptation to current consumer expectations (lower acidity, increased unctuousness), reference YC-X11.
a bifidogenic ferment, consisting of Bifidobacterium lactis, reference BB-12.

Formulation:

3 yogurts can be made using each of the ferments.

| Ingredient | Proportions in the yogurt |
|---|---|
| Water | 80.96% |
| Skim milk powder | 9% |
| Resistant dextrin | 10% |
| Aspartame | 0.024% |
| Acesulfame K | 0.016% |
| Ferments | see below |

The ferments comprise around 4.8 g of traditional or modern ferments per 100 liters of milk and also 2 g per 100 liters of milk with the bifidus ferment.

Protocol:
Hydrate the skim milk powder in water for 15 minutes with stirring (800 rpm (revolutions per minute)).
Add the resistant dextrin, and stir for 7 minutes at 500 rpm.
Pasteurize the solution in a coil immersed in a boiling water bath, residence time of the milk in the coil: 7 minutes.
Let the milk cool to 44° C. Then add the sweeteners previously diluted to 10% in sterile water and the ferments diluted in pasteurized milk.
Place the milk in an oven at 44° C. and monitor the pH to a value of 4.4.
Stop the fermentation: stir the yogurt for 1 minute at 500 rpm and pour it into glass pots, stored at 4° C.

### Example 4

### Carbonated Soft Drink

A carbonated soft drink (soda) containing the resistant dextrin of example 2 can be produced by following the recipe and the protocol below.

Amounts in grams per 1 liter of drink:

| Ingredients | Proportions in the drink (g) |
|---|---|
| Resistant dextrin | 73.68 |
| Aspartame | 0.118 |
| Acesulfame K | 0.118 |
| Lemon flavoring | 0.7 |
| Citric acid | 1.9 |
| Sodium benzoate | 0.09 |
| Carbonated water | qs for 1 L |

0.5 liters of carbonated water is prepared. The sweeteners or sugar substitute are then added. The remainder of he ingredients are then incorporated and water is added up to a volume of 1 liter.

### Example 5

### Soups

A concentrated tomato soup can be prepared using the resistant dextrin of example 2, according to the following protocol.

Recipe in g per 100 g:

| | Soup 1 | Soup 2 |
|---|---|---|
| Cleargum ® CO01 | 0.3 | 0.3 |
| Whey | 0.37 | 0.37 |
| Soybean oil | 3 | 3 |
| Water at 90° C. | 9.8 | 9.8 |
| Sucrose | 5 | 5 |
| Clearam ® CH20 | 2.4 | 2.4 |
| 28% tomato concentrate | 36.0 | 36.0 |
| Citric acid | 0.1 | 0.1 |
| Water | 35.6 | 28.17 |
| Resistant dextrin | 7.73 | 14.86 |

Protocol:

Mix the oil, the water at 90° C., the CLEARGUM00001 emulsifier, and the whey in the bowl of a KENWOOD® mixer for 10 minutes at maximum speed.

Separately mix the sucrose, the CLEARAMOCH20 modified starch, the tomato concentrate, the citric acid and the water: Cook in a water bath up to 80° C.

Mix the tomato sauce thus obtained with the previous emulsion for 30 seconds. Can the soup, and sterilize at 110° C. for 50 minutes. The pH of the soup is 4.2. Before consuming, the soup is diluted to 50% by weight in water.

### Example 6

### Gelatin Chewing Paste

The resistant dextrin of the invention (example 2) can be used to produce a gelatin chewing paste.

A-Formula

| | Composition by | Finished product |
|---|---|---|
| | weight | composition (%) |
| A) Resistant dextrin | 595.0 | 69.7% |
| Erythritol | 76.0 | 9.4% |
| Water | 252.0 | — |
| B) Vegetable fats | 4.0 | 4.9% |
| Glyceryl monostearate | 4.0 | 0.5% |
| C) Gelatin (type A-180 blooms) | 8.0 | 1.0% |
| Water | 1.0 | — |
| D) Acesulfanne K | 0.7 | 0.1% |
| Cherry flavoring | 7.0 | 0.9% |
| Citric acid solution (50% DM) | 5.3 | 0.3% |
| Red coloring agent | qs | — |
| Water in the finished product | | 13.2% |

B-Preparation Method
Cook the mixture (A) at 110° C. (Brix=85.2) under atmospheric pressure,
Leave to cool while mixing and add the mixture B (previously melted at 60° C.), the gelatin solution C maintained at 60° C., then D when the temperature of the mixture reaches 60° C.,
Cool the paste,
Stretch the paste (1 min., i.e. 50 revolutions of the arm of the pulling machine),
Shape,
Cut and package.

### Example 7

### Gelatin-Free Chewing Paste

The resistant dextrin of the invention (example 2) can be used to produce a gelatin-free chewing paste.

A-Formula

| | Composition by | Finished product |
|---|---|---|
| | weight | composition (%) |
| A) Resistant dextrin | 595.0 | 68.9% |
| Erythritol | 76.0 | 9.3% |
| Water | 264.0 | — |
| B) Vegetable fats | 48.0 | 5.9% |
| Glyceryl monostearate | 4.0 | 0.5% |
| C) Acesulfanne K | 0.7 | 0.1% |
| Cherry flavoring | 7.0 | 0.9% |
| Citric acid solution (50% solids) | 5.3 | 0.3% |
| Red coloring agent | qs | — |
| Water in the finished product | | 14.2% |

B-Preparation Method
Cook the mixture (A) at 108° C. (Brix=83.5) under atmospheric pressure,
Leave to cool while mixing and add the mixture B (previously melted at 60° C.), then C when the temperature of the mixture reaches 60° C.,
Cool the paste,
Stretch the paste (1 min., i.e. 50 revolutions of the arm of the pulling machine),
Shape,
Cut and package.

### Example 8

### Caramel

The resistant dextrin of the invention (example 2) can be used to produce a caramel.

A-Formula

| | Composition by | Finished product |
|---|---|---|
| | weight | composition (%) |
| A) Resistant dextrin | 59.0 | 68.3% |
| Erythritol | 76.0 | 9.2% |
| Water | 264.0 | — |
| B) Vegetable fats | 4.0 | 5.8% |
| Glyceryl monostearate | 4.0 | 0.5% |
| C) Acesulfanne K | 0.7 | 0.1% |
| Caramel flavoring | 7.0 | 0.8% |
| E 341 caramel coloring agent | 5.3 | 0.6% |
| Water in the finished product | | 15.2% |

B-Preparation Method
Cook the mixture (A)+the mixture (B) (previously melted at 60° C.) at 108° C. (Brix=84.5) under atmospheric pressure,
During the cooking, add the mixture C,
Cool,
Shape,
Cut and package.

### Example 9

### Filling Jelly

The resistant dextrin of the invention (example 2) can be used to prepare a filling jelly.

The ingredients (see table below) are mixed, then the mixture is cooked on an open flame, at boiling, for a time necessary to obtain a Brix of 90. The cooking parameters are described in the table below.

| Ingredients | Proportions in the jam (g) |
|---|---|
| Resistant dextrin | 200 |
| Water | 50 |
| Apricot puree | 350 |
| Sucrose | 400 |

### Example 10

### Fruit Preparation for Yogurts

The resistant dextrin of the invention (example 2) can be used to produce a fruit preparation for yogurts.

| | Proportions | Proportions in |
|---|---|---|
| | in the fruit | the sugar-free |
| Ingredients | preparation (g) | fruit preparation (g) |
| Sucrose | 20.7 | |
| Glucose syrup | 13.8 | 0 |
| Fruit puree ** | 21 | 21 |
| CLEARAM ®CR0820 | 1.6 | 1.6 |
| modified starch | | |
| Resistant dextrin | 7.5 | 42 |
| Water | 34.65 | 34.65 |
| Pectin | 0.6 | 0.6 |
| Unipectine ™ | | |
| Aspartame | 0 | 0.9 |
| Acesulfame K | 0 | 0.9 |
| Citric acid*** | 0.1 | 0.1 |
| Potassium sorbate | 0.05 | 0.05 |

** frozen fruit puree concentrated to 50 brix
*** % citric acid to be adjusted to obtain a pH of 3.8 (pH of a fruit preparation intended to be mixed with a yogurt).

Procedure:

The fruits are mixed with half the sucrose or intense sweeteners, the glucose syrup, the modified starch and the citric acid.

The pectin-resistant dextrin solution and any remaining sucrose are heated in water at 85° C. for 5 minutes and added to the previous mixture.

This is cooked at 95° C. for 5 minutes and the potassium sorbate is added.

### Example 11

### Stackable Rolled Snacks

Low-fat stackable rolled snacks can be prepared according to the following formula with the resistant dextrin of example 2.

| Ingredients | Proportions (g) |
|---|---|
| Potato flakes | 43.3 |
| Potato granules | 19.7 |
| Corn starch | 16.7 |
| Wheat starch | 9.0 |
| Dimodan ® PVP (emulsifier) | 3.0 |
| Resistant dextrin | 6.7 |
| Dextrose | 1.6 |

Low-fat, high-fiber stackable rolled snacks are prepared according to the formula. The various ingredients are mixed and water is incorporated to obtain a 40% moisture content of the paste. The mixture obtained is passed through a cold extruder in order to obtain a dough, which is then rolled and cut into chips. The chips are then fried in oil at 195° C. for 15 seconds.

### Example 12

### Hard Candies

Hard candies comprising the resistant dextrin of example 2 can be prepared from the following syrups:
Test 1
   90% Isomalt+10% resistant dextrin on dry basis/cooking temp.=180° C.
Test 2
   80% Isomalt+20% resistant dextrin on dry basis/cooking temp.=180° C.
Test 3
   70% Isomalt+30% resistant dextrin on dry basis/cooking temp.=180° C.
Test 4
   60% Isomalt+40% resistant dextrin on dry basis/cooking temp.=180° C.

All the mixtures are made at 75% DM, and are cooked in a cooker at the temperatures indicated, so as to obtain water contents of less than 3%. The cooked masses are placed on a cold table and shaped.

### Example 13

### Brioches

Brioches can be made, using the resistant dextrin of example 2.

| | A | B |
|---|---|---|
| | 5% Resistant | 10% Resistant |
| | dextrin | dextrin |
| Leforest flour (g) | 1014.7 | 984.8 |
| Vital gluten (g) | 40 | 40 |
| Glucose syrup (g) | 175 | 85 |
| Whole egg 4° C. (g) | 150 | 150 |
| Fresh butter 85% DM (g) | 200 | 200 |
| Water (g) | 250 | 270 |
| Resistant dextrin (g) | 100 | 200 |
| Bakers yeast (g) | 50 | 50 |
| Salt (g) | 20 | 20 |
| Enzyme (g) | 0.1 | 0 |
| 1% Ascorbic acid (ml) | 0 | 0 |
| Cysteine (g) | 0.2 | 0.2 |
| Total (g) | 2000 | 2000 |
| Water temperature | 25° C. | 30° C. |
| Spiral kneader speed 1 | 1 min | 1 min |
| Spiral kneader speed 2 | 8 min | 15 min |
| Temperature at end of | 26.5° C. | 27° C. |
| kneading | | |
| Resting time at. room temp | 15 min | 15 min |
| Rising time at 28° C., 85% H₂O | 1 h 45 min | 1 h 45 min |

Weighing and rounding of 500 g brioches and 60 g mini brioches.

The mini brioches are shaped manually.

Baking in a rotary oven at 190° C., brioches for 23 minutes, mini brioches for 15 minutes. Egg and water glaze.

### Example 14

### High-Fiber Sandwich Loaves

Loaves can be made, using the resistant dextrin of example 2.

The dough formulae used are described in detail in the table below (the percentages indicate the proportion in the finished product).

Baking in a rotary oven at 200° C. for 25 minutes.

| | Test 1 | Test 2 |
|---|---|---|
| Leforest flour (g) | 2020 | 2020 |
| Vital gluten (g) | 120 | 120 |
| Resistant dextrin (g) | 200 | 150 |
| Pea fiber (g) | 0 | 50 |
| Dry yeast (g) | 30 | 30 |
| Salt (g) | 40 | 40 |
| 1% Ascorbic acid (ml) | 0.1 | 0.1 |
| Water | 1190 | 1190 |
| Enzyme (g) | 0.3 | 0.3 |
| Skim milk powder | 70 | 70 |
| Rapeseed oil | 150 | 150 |
| Calcium propionate | 10 | 10 |
| Spiral kneader S1 | 1 min | 1 min |
| Spiral kneader S2 | 18 min | 11 min |
| Rising time at 30° C., 85% relative humidity | 2 h 15 min | 1 h 30 min |
| Weight of the pieces of dough | 450 g | 450 g |

### Example 15

### Breads

The breads can be made, using the resistant dextrins of examples 1 and 2, according to a French bread formula using a bread-making wheat flour (moisture content 15.4%, protein 10.9%, alveogram W280 and P/L 0.75).

Kneading the dough in a VMI spiral kneader for 2 minutes at speed 1, followed by 9 minutes of kneading at speed 2.

Dough left to stand for 10 minutes at 20° C. before being cut into 500 g pieces and shaped.

Fermentation of the dough pieces carried out at 24° C. and 75% relative humidity for around 2 h 30 min then baking carried out at 240° C. for 24 minutes in a peel oven.

The table below summarizes the detailed formulae of the composition of the doughs:

| | Test 1 | Test 2 | Test 3 | Test 4 | Test 5 | Test 6 |
|---|---|---|---|---|---|---|
| Wheat flour | 57.69 | 51.49 | 41.08 | 39.29 | 32.40 | 30.59 |
| Wheat gluten | 1.40 | 2.19 | 9.04 | 9.35 | 10.72 | 7.76 |
| Pea fiber | 0 | 0 | 0 | 3.44 | 4.35 | 3.10 |
| Resistant dextrin | 8.49 | 7.58 | 0 | 0 | 0 | 6.54 |
| of example 2 | | | | | | |
| Resistant dextrin | 0 | 0 | 7.31 | 9.45 | 10.84 | 0 |
| of example 1 | | | | | | |
| Resistant starch | 0 | 6.32 | 5.6 | 5.82 | 7.23 | 0 |
| Pea protein | 0 | 0 | 4.38 | 0 | 0 | 14.06 |
| Salt | 1.71 | 1.73 | 1.69 | 1.68 | 1.68 | 1.52 |
| Fresh yeast | 0.68 | 0.67 | 0.67 | 0.67 | 0.66 | 0.44 |
| Improvers | 0.02 | 0.02 | 0.24 | 0.3 | 2.11 | 2.55 |
| Water | 30 | 30 | 30 | 30 | 30 | 30 |
| Total | 100 | 100 | 100 | 100 | 100 | 100 |

### Example 16

### Cookies

Sugar-free cookies can be made, with the resistant dextrin of example 2, the composition of the doughs of which is presented in the table below.

| | Test 1 | Test 2 | Test 3 |
|---|---|---|---|
| fat | 16.20 | 16.39 | 16.14 |
| soy lecithin | 0.86 | 0.87 | 0.43 |
| maltitol | 21.61 | 21.85 | 21.52 |
| wheat flour | 9.70 | 20.67 | 0.09 |
| fat-reduced cocoa powder | 4.15 | 0.00 | 0.00 |
| pea fiber | 4.86 | 7.87 | 5.81 |
| Resistant dextrin | 13.34 | 14.01 | 15.02 |
| resistant starch | 10.78 | 0.00 | 21.98 |
| pea protein | 13.34 | 14.01 | 14.82 |
| whole egg | 0.00 | 0.00 | 0.11 |
| baking powder | 1.30 | 0.77 | 0.76 |
| Salt | 0.32 | 0.33 | 0.32 |
| flavorings | 0.54 | 0.22 | 0.00 |
| water | 3.00 | 3.00 | 3.00 |
| TOTAL | 100.00 | 100.00 | 100.00 |

The water and the baking powder are weighed and then mixed for 5 minutes in a Hobart kneader at speed 1.

The fat and the soy lecithin are added and the mixture is stirred for one minute at speed 1, then 4 minutes at speed 2. Then the eggs, if needed, are added before further homogenization.

The rest of the powders: flour, salt, flavorings, fat-reduced cocoa powder if needed, maltitol, pea fiber, resistant dextrin, resistant starch and pea proteins if needed, are added and then mixed in the kneader. The compositions and products are given according to the compositions presented in the table above. Everything is kept stirring for 10 minutes at speed 1, with an interruption to scrape the edges of the kneader and the stirring blade.

The cookies are formed with a rotary molding machine and placed on a baking sheet.

The mounds of dough are placed in the rotary oven at 200° C. for 10 minutes and are allowed to cool to 25° C.

1. A process for manufacturing a resistant dextrin, comprising:
a) a step of dehydrating and acidifying a pea starch to provide a dehydrated and acidified pea starch composition;
b) a step of heat treatment of the starch composition provided in step a) to form a dextrinized starch;
c) one or more steps of treating this dextrinized starch to form the resistant dextrin; and
d) a step of recovering this resistant dextrin.

2. The process as claimed in claim 1, characterized in that at least one treatment step comprises a filtration and/or demineralization step.

3. The process as claimed in claim 1, characterized in that the water content in the starch composition during at least one part of step b) is less than or equal to 10%, generally less than or equal to 6%, for example less than or equal to 4%, by mass relative to the total mass of the composition.

4. The process as claimed in claim 1, characterized in that the pea starch used in step a) comprises a total lipid content of less than 0.10%, generally ranging from 0.01 to 0.08%, for example from 0.02 to 0.05%, in particular from 0.02 to 0.04% by dry mass relative to the dry mass of the starch.

5. The process as claimed in claim 1, characterized in that at least one treatment step comprises a fractionation step.

6. The process as claimed in claim 1, characterized in that the pea starch used in step a) has an amylose/amylopectin mass ratio ranging from 32:68 to 45:55.

7. The process as claimed in claim 1, characterized in that the ash content of the pea starch used in step a) is less than 1%, for example less than 0.2%.

8. The process as claimed in claim 1, characterized in that the pea starch used in step a) is a smooth pea starch of yellow pea type.

9. The process as claimed in claim 1, characterized in that the pea starch used in step a) is a native starch.

10. The process as claimed in claim 1, characterized in that the heat treatment step b) is carried out at least in part at a temperature ranging from 60 to 250° C., for example at a temperature ranging from 120 at 220° C., preferably at a temperature ranging from 160 to 210° C.

11. The process as claimed in claim 1, characterized in that the heat treatment is carried out in a reactor chosen from an extruder, a thin-film reactor or a thermostatic chamber, preferentially an extruder or a thin-film reactor, very preferentially a thin-film reactor.

12. The process as claimed in claim 1, characterized in that the starch composition is acidified during step a) with an acid chosen from hydrochloric acid, sulfuric acid, nitric acid, phosphoric acid, citric acid or a mixture thereof, preferentially hydrochloric acid.

13. The process as claimed in claim 1, characterized in that at least one of the treatment steps c) comprises a step of enzymatic treatment of the dextrinized starch.

14. The process as claimed claim 1, characterized in that at least one of the treatment steps c) comprises a fractionation step to reduce the sugar content of the dextrinized starch.

15. The process as claimed in claim 1, characterized in that the resistant dextrin recovered has:
from 15% to 45%, preferably from 20 to 42%, for example from 28 to 40%, of 1→6 glycosidic bonds relative to the total number of 1→2, 1→3, 1→4 and 1→6 glycosidic bonds,
a reducing sugar content of less than 30%, for example ranging from 3 to 25%, in particular ranging from 4 to 19%, more particularly from 4 to 12%, as glucose equivalent, by mass relative to the dry mass of the resistant dextrin.

16. The process as claimed in claim 1, characterized in that the resistant dextrin recovered has:
a polydispersity index of less than 5, generally ranging from 1.5 to 4, and
a number-average molecular mass Mn of less than 4500 g/mol, generally ranging from 500 to 3500 g/mol, for example ranging from 800 to 3000 g/mol, in particular from 900 to 1500 g/mol.

17. The process as claimed in claim 1, characterized in that the amount of fiber in the resistant dextrin according to the AOAC 2001.03 standard greater than 60%, preferentially ranging from 65 to 99%, generally from 70 to 95%.

18. A resistant pea dextrin having an amount of fiber according to the AOAC 2001.03 standard of greater than 60%.

19. A resistant pea dextrin, having an amount of fiber according to the AOAC 2001.03 standard of greater than 60%, obtained by the process according to claim 1.

20. A food or pharmaceutical composition, comprising a resistant pea dextrin having an amount of fiber according to the AOAC 2001.03 standard of greater than 60%.
